(19) United States
(12) Patent Application Publication
(10) Pub. No.: US 2022/0202016 A1
(43) Pub. Date: Jun. 30, 2022

(54) COMPOSITION FOR INCREASING PRODUCTIVITY IN PLANTS

(71) Applicant: CH BIOTECH R&D CO., LTD., Nantou City (TW)

(72) Inventors: Chen-Pang WU, Nantou City (TW); Cho-Chun HUANG, Nantou City (TW); Gui-Jun LI, Nantou City (TW); Kai XIA, Nantou City, (TW)

(21) Appl. No.: 17/136,162

(22) Filed: Dec. 29, 2020

(51) Int. Cl. A01N 43/90; A01N 37/44; A01N 33/12; A01N 43/38

(52) U.S. Cl. CPC A01N 43/90; A01N 43/38; A01N 33/12; A01N 37/44

(57) ABSTRACT

The invention relates to a composition for increasing productivity in plants. The composition includes cytokinin, gamma aminobutyric (GABA), and choline chloride. The invention also relates to a method for increasing productivity in plants.

### BACKGROUND OF THE INVENTION

### 1. FIELD OF THE INVENTION

The present invention relates to a composition for increasing productivity in plants. More particularly, the present invention relates to a composition including cytokinin, gamma aminobutyric (GABA), and choline chloride.

### 2. DESCRIPTION OF THE PRIOR ART

Carbon dioxide (CO₂) is one of the most common greenhouse gases, which trap heat in the atmosphere and raise global temperature. Plants absorb carbon dioxide from the atmosphere and then convert carbon dioxide and water into carbohydrates and oxygen via photosynthesis process. If a plant has increased photosynthesis activity and capacity to absorb carbon dioxide, it would be expected to benefit the environment and increase plant growth and yield.

Nitrogen pollution is caused by excess nitrogen in the air and water, which threatens human health and ecosystems. Agriculture is the main source of nitrogen pollution. Typically, crops cannot take up all applied nitrogen fertilizer from the soil, and a large portion of nitrogen fertilizer is lost due to fertilizer runoff, leaching and/or ammonia emission, which contributes to nitrogen pollution. Efficient use of nitrogen is essential for economic crop production and environmental protection.

Therefore, there is an urgent need to improve carbon absorption and nitrogen usage in plants to reduce greenhouse gas and nitrogen pollution, and further increase productivity in plants.

### SUMMARY OF THE INVENTION

In one aspect, the present invention relates to a concentrate composition for increasing productivity in plants. The concentrate composition comprises between about 0.005% to about 0.96% by weight (wt%) cytokinin; between about 0.04 wt% to about 8 wt% γ-Aminobutyric acid (GABA); between about 0.08 wt % to about 16 wt % choline chloride; and water.

In another aspect, the present invention relates to a ready to use composition for increasing productivity in plants. The ready to use composition comprises between about 0.000012 wt % to about 0.0384 wt % cytokinin; between about 0.0001 wt % to about 0.32 wt % γ-Aminobutyric acid (GABA); between about 0.0002 wt % to about 0.64 wt % choline chloride; and water.

In another aspect, the present invention relates to a method for increasing productivity in plants.

The present invention is illustrated but not limited by the following embodiments and drawings.

### BRIEF DESCRIPTION OF THE DRAWINGS

FIG. 1 shows electron transport rates (ETR) of plants for soybean, corn, canola, and tomato that were applied with (test groups) or without (control groups) the composition of the present invention in Example 1. The numbers above the bars represent the increased rate of test groups compared to their corresponding control groups.

FIG. 2 shows soluble sugar content of plants for soybean, corn, canola, wheat, and tomato that were applied with (test groups) or without (control groups) the composition of the present invention in Example 1. The numbers above the bars represent the increased rate of test groups compared to their corresponding control groups.

FIG. 3 shows activities of nitrate reductase (NR) of plants for soybean, corn, canola, wheat, and tomato that were applied with (test groups) or without (control groups) the composition of the present invention in Example 1. The numbers above the bars represent the increased rate of test groups compared to their corresponding control groups.

FIG. 4 shows activities of glutamine synthetase (GS) of plants for soybean, corn, canola, wheat, and tomato that were applied with (test groups) or without (control groups) the composition of the present invention in Example 1. The numbers above the bars represent the increased rate of test groups compared to their corresponding control groups.

FIG. 5 shows activities of glutamate synthase (GOGAT) of plants for soybean, corn, canola, wheat, and tomato that were applied with (test groups) or without (control groups) the composition of the present invention in Example 1. The numbers above the bars represent the increased rate of test groups compared to their corresponding control groups.

FIG. 6 shows content of soluble proteins of plants for soybean, corn, canola, wheat, and tomato that were applied with (test groups) or without (control groups) the composition of the present invention in Example 1. The numbers above the bars represent the increased rate of test groups compared to their corresponding control groups.

FIG. 7 shows total nitrogen content of plants for soybean, corn, canola, wheat, and tomato that were applied with (test groups) or without (control groups) the composition of the present invention in Example 1. The numbers above the bars represent the increased rate of test groups compared to their corresponding control groups.

FIG. 8 shows yields of soybeans that were applied with (test groups 1-1, 1-2, and 1-3) or without (control group 1) the composition of the present invention in Field Trail 1 of Example 2.

FIG. 9A shows seed pods on main stems of soybean plants that were not applied with the composition of the present invention (control group 1) in Field Trail 1 of Example 2. FIG. 9B shows seed pods on main stems of soybean plants that were applied with the composition of the present invention once at the stage of R1 (beginning flowering) (test group 1-1) in Field Trail 1 of Example 2. FIG. 9C shows seed pods on main stems of soybean plants that were applied with the composition of the present invention three times (test group 1-3) in Field Trail 1 of Example 2.

FIG. 10 shows yields of soybeans that were applied with (test groups 2-1 and 2-2) or without (control group 2) the composition of the present invention in Field Trail 2 of Example 2.

FIG. 11 shows yields of corn that was applied with (test group) or without (control group) the composition of the present invention in the field trail of Example 3.

FIG. 12 shows yields of canola that was applied with (test group) or without (control group) the composition of the present invention in the field trail of Example 4.

FIG. 13 shows yields of cotton that was applied with (test groups 1 and 2) or without (control group) the composition of the present invention in the field trail of Example 5.

FIG. 14 shows yields of marketable tomato that was applied with (test group) or without (control group) the composition of the present invention in the field trail of Example 6.

FIG. 15 shows market value of tomato that was applied with (test group) or without (control group) the composition of the present invention in the field trail of Example 6.

FIG. 16 shows the percentages of marketable tomato that was applied with (test group) or without (control group) the composition of the present invention after 17 days and 30 days storage in Example 6.

FIG. 17 shows yields of potato that was applied with (test group) or without (control group) the composition of the present invention in the field trail of Example 7.

### DETAILED DESCRIPTION OF THE PREFERRED EMBODIMENT

The present invention provides a composition for increasing productivity in plants. The composition comprises cytokinin, γ-aminobutyric acid (GABA), and choline chloride. In some embodiments, the cytokinin is selected from N6-furfuryladenine (kinetin), 6-Benzylaminopurine (BA), zeatin (ZT), N6-(2-isopentenyl) adenine (2ip), diphenylurea (DPU), and thidiazuron (TDZ). In some embodiments, the cytokinin is kinetin.

In some embodiments, the composition of the present invention is a concentrate composition, including between about 0.005% to about 0.96% by weight (wt%) cytokinin, between about 0.04 wt % to about 8 wt % γ-Aminobutyric acid (GABA), and between about 0.08 wt % to about 16 wt % choline chloride.

In some embodiments, the concentration of cytokinin in the concentrate composition is between about 0.005 wt % to about 0.96 wt %, and preferably is, but is not limited to, about 0.005 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 0.96 wt %, or any concentration between about 0.005 wt % to about 0.96 wt %, such as about 0.0126 wt %, about 0.078 wt %, about 0.319 wt %. In some embodiments, the concentration of cytokinin in the concentrate composition is about 0.12 wt %. In some embodiments, the concentration of cytokinin in the concentrate composition is about 0.24 wt %.

In some embodiments, the concentration of GABA in the concentrate composition is between about 0.04 wt % to about 8 wt %, and preferably is, but is not limited to, about 0.04 wt %, about 0.08 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, or any concentration between about 0.04 wt % to about 8 wt %, such as about 0.097 wt %, about 1.062 wt %, about 2.52 wt %. In some embodiments, the concentration of GABA in the concentrate composition is about 1 wt %. In some embodiments, the concentration of GABA in the concentrate composition is about 2 wt %.

In some embodiments, the concentration of choline chloride in the concentrate composition is between about 0.08 wt % to about 16 wt %, and preferably is, but is not limited to, about 0.08 wt %, about 0.1 wt %, about 0.25 wt %, about 0.5 wt %, about 0.75 wt %, about 1 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, about 10 wt %, about 10.5 wt %, about 11 wt %, about 11.5 wt %, about 12 wt %, about 12.5 wt %, about 13 wt %, about 13.5 wt %, about 14 wt %, about 14.5 wt %, about 15 wt %, about 15.5 wt %, about 16 wt %, or any concentration between about 0.08 wt % to about 16 wt %, such as about 0.098 wt %, about 4.234 wt %, about 12.607 wt %. In some embodiments, the concentration of choline chloride in the concentrate composition is about 2 wt %. In some embodiments, the concentration of choline chloride in the concentrate composition is about 4 wt %.

In some embodiments, the composition of the present invention is a ready to use composition, including between about 0.000012 wt % to about 0.0384 wt % cytokinin, between about 0.0001 wt % to about 0.32 wt % GABA, and between about 0.0002 wt % to about 0.64 wt % choline chloride.

In some embodiments, the concentration of cytokinin in the ready to use composition is between about 0.000012 wt % to about 0.0384 wt %, and preferably is, but is not limited to, about 0.000012 wt %, about 0.000025 wt %, about 0.00005 wt %, about 0.000075 wt %, about 0.0001 wt %, about 0.00025 wt %, about 0.0005 wt %, about 0.00075 wt %, about 0.001 wt %, about 0.0025 wt %, about 0.005 wt %, about 0.0075 wt %, about 0.01 wt %, about 0.015 wt %, about 0.02 wt %, about 0.025 wt %, about 0.03 wt %, about 0.035 wt %, about 0.0384 wt %, or any concentration between about 0.000012 wt % to about 0.0384 wt%, such as about 0.000163 wt %, about 0.00984 wt %, about 0.0334 wt %. In some embodiments, the concentration of cytokinin in the ready to use composition is about 0.0003 wt %. In some embodiments, the concentration of cytokinin in the ready to use composition is about 0.0006 wt %. In some embodiments, the concentration of cytokinin in the ready to use composition is about 0.0012 wt %. In some embodiments, the concentration of cytokinin in the ready to use composition is about 0.0096 wt %. In some embodiments, the concentration of GABA in the ready to use composition is between about 0.0001 wt % to about 0.32 wt %, and preferably is, but is not limited to, about 0.0001wt %, about 0.00025 wt %, about 0.0005 wt %, about 0.00075 wt %, about 0.001 wt %, about 0.0025 wt %, about 0.005 wt %, about 0.0075 wt %, about 0.01 wt %, about 0.05 wt %, about 0.075 wt %, about 0.1 wt %, about 0.15 wt %, about 0.2 wt %, about 0.25 wt %, about 0.3 wt %, about 0.32 wt %, or any concentration between about 0.0001 wt% to about 0.32 wt %, such as about 0.0083 wt %, about 0.0162 wt %, about 0.271 wt %.

In some embodiments, the concentration of GABA in the ready to use composition is about 0.0025 wt %. In some embodiments, the concentration of GABA in the ready to use composition is about 0.005 wt %. In some embodiments, the concentration of GABA in the ready to use composition is about 0.01 wt %. In some embodiments, the concentration of GABA in the ready to use composition is about 0.08 wt %.

In some embodiments, the concentration of choline chloride in the ready to use composition is between about 0.0002 wt % to about 0.64 wt %, and preferably is, but is not limited to, about 0.0002 wt %, about 0.00025 wt %, about 0.0005 wt %, about 0.00075 wt %, about 0.001 wt %, about 0.0025 wt %, about 0.005 wt %, about 0.0075 wt %, about 0.01 wt %, about 0.025 wt %, about 0.05 wt %, about 0.075 wt %, about 0.1 wt %, about 0.2 wt %, about 0.3 wt %, about 0.4 wt %, about 0.5 wt %, about 0.6 wt %, about 0.64 wt %, or any concentration between about 0.0002 wt % to about 0.64 wt %, such as about 0.00083 wt %, about 0.0162 wt %, about 0.371 wt %. In some embodiments, the concentration of choline chloride in the ready to use composition is about 0.005 wt %. In some embodiments, the concentration of choline chloride in the ready to use composition is about 0.01 wt %. In some embodiments, the concentration of choline chloride in the ready to use composition is about 0.02 wt %. In some embodiments, the concentration of choline chloride in the ready to use composition is about 0.16 wt %.

In some embodiments, the composition for increasing productivity in plants of the present invention may include one or more adjuvant. For example, the composition may include a surfactant and/or a drift control agent. Exemplary surfactants include, but are not limited to, cationic surfactants, anionic surfactants, zwitterionic surfactants, and nonionic surfactants, preferably including but not limited to, Tween 20, Tween 40, Tween 60, Tween 65, Tween 80, Tween 85, Laureth-4, Ceteth-2, Ceteth-20, Steareth-2, PEG40, PEG100, PEG150, PEG200, PEG600, Span 20, Span 40, Span 60, Span 65, Span 80. An exemplary drift control agent includes LI700®, which is commercially available from Loveland Products (Loveland, Colo., USA).

In some embodiments, the concentration of the adjuvant is 0.01˜1% (v/v), and preferably is, but is not limited to, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1% (v/v). In some embodiments, the concentration of the adjuvant is 0.1% (v/v), In some embodiments, the concentration of the adjuvant is 0.125% (v/v). In some embodiments, the concentration of the adjuvant is 0.25% (v/v). Suitable concentration ranges for the concentrate composition of the present invention are provided in Table 1, and suitable concentration ranges for the ready to use composition of the present invention are provided in Table 2. In some embodiments, the concentrate composition and the ready to use composition can consist of or consist essentially of the components listed in Table 1 and 2, respectively.

TABLE 1
Suitable concentrate compositions

| | First example | Second example | Third example |
|---|---|---|---|
| Component | range (wt %) | range (wt %) | range (wt %) |
| Cytokinin | 0.00096-1.92 | 0.005-0.96 | 0.06-0.48 |
| GABA | 0.008-16 | 0.04-8 | 0.5-4 |
| Choline | 0.016-32 | 0.08-16 | 1-8 |
| chloride | | | |

TABLE 2
Suitable ready to use compositions

| | First example | Second example | Third example |
|---|---|---|---|
| Component | range (wt %) | range (wt %) | range (wt %) |
| Cytokinin | 0.0000024-0.0768 | 0.000012-0.0384 | 0.00015-0.0192 |
| GABA | 0.00002-0.64 | 0.0001-0.32 | 0.00125-0.16 |
| Choline | 0.00004-1.28 | 0.0002-0.64 | 0.0025-0.32 |
| chloride | | | |

The present invention also provides a method for increasing productivity in plants, including a step of applying the ready to use composition for increasing productivity in plants of the present invention to the plants.

In some embodiments, the composition of the present invention is applied to a target plant during the vegetative phase. In some embodiments, the composition of the present invention is applied to a target plant during the reproductive phase. The composition of the present invention can be applied to different plants, such as, but not limited to, soybean, corn, canola, wheat, tomato, potato, and cotton. In some embodiments, the composition of the present invention is applied to plant foliage (for example, leaves, stems, flowers and/or fruits), for example as a foliar application or foliar spray. In some embodiments, the composition of the present invention is applied to plant roots, such as by a soil application or soil drench, and/or to seeds, such as by a seed treatment.

In some embodiments, the method for increasing productivity in plants includes a further step of applying a second composition or a pre-treatment composition before the step of applying the ready to use composition to the plants. The second composition may consist essentially of between about 0.00027% wt % to about 0.00133 wt % 3-indolebutryic acid (IBA) and between about 0.00005 wt % to about 0.00023 wt % cytokinin. In some embodiments, the cytokinin of the second composition is kinetin.

The composition of the present invention increases productivity in plants by at least one of increasing electron transport rate in the plants, increasing sugar content in leaves of the plants, increasing activity of nitrate reductase (NR) in the plants, increasing activity of glutamine synthetase (GS) in the plants, increasing activity of glutamate synthase (GOGAT) in the plants, increasing content of soluble proteins in the plants, and increasing total nitrogen content in the plants.

The composition of the present invention has demonstrated remarkable increases in electron transport rate in target plants, and/or sugar content in leaves of target plants, and/or activity of nitrate reductase (NR) in target plants, and/or activity of glutamine synthetase (GS) in target plants, and/or activity of glutamate synthase (GOGAT) in target plants, and/or content of soluble proteins in target plants, and/or total nitrogen content in target plants, leading to increasing productivity in target plants. It has been found that when cytokinin, GABA, and choline chloride are combined in the composition of the present invention, the plant growth regulating actions of the respective components are increased synergistically, and the combination of the components exhibits a marked synergistic effect not seen when the components are used individually.

Unless otherwise defined, all technical and scientific terms used herein have the same meaning as commonly understood by one of ordinary skill in the art to which this invention pertains. In the case of conflict, the present document, including definitions will control.

As used herein, the term “cytokinin” refers to a class of plant growth regulators that enhance cell division, cell differentiation, and axillary bud growth, and inhibit apical dominance. There are two types of cytokinins based on their chemical structures: adenine-type and phenylurea-type cytokinin. Most cytokinins are synthesized in root tip and transported to photosynthetic tissues through xylem. Although roots are the major site of cytokinin biosynthesis, they are not the only site. Cambium and possibly all actively dividing tissues, such as embryo, leaves, fruits, are responsible for the synthesis of cytokinin. Examples of cytokinin include, but are not limited to, N6-furfuryladenine (kinetin), 6-Benzylaminopurine (BA), zeatin (ZT), N6-(2-isopentenyl) adenine (2ip), diphenylurea (DPU), and thidiazuron (TDZ).

As used herein, the term “γ-Aminobutyric acid (GABA),” also known as 4-aminobutanoic acid, refers to a non-protein amino acid having the formula of C₄H₉NO₂ and the following chemical structure:

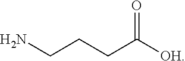

GABA acts as a carbon and nitrogen source as well as an endogenous signaling molecule, which is involved in plant growth and development regulations.

As used herein, the term “choline chloride” refers to an organic compound having the formula of ((CH₃)₃N(Cl)CH₂CH₂OH). Choline chloride is a precursor of phosphatidylcholines, which are major components of biological membranes. As used herein, the term “electron transport rate (ETR)” refers to transport rate of electrons released by water splitting during photosynthesis. Since energy is generated during electron transportation, the faster the electron transport rate is, the more energy (ATP) is generated, which helps plants synthesize more sugar from CO₂.

As used herein, the term “sugar content in leaves” refers to the content of soluble sugar, such as, but not limited to, glucose and sucrose, in leaves of a plant. Plants convert CO₂ into sugar in the Calvin cycle, and therefore, sugar content in leaves directly represents the abilities of a plant to absorb and assimilate CO₂.

As used herein, the term “nitrogen assimilation” refers to the formation of organic nitrogen compounds, such as amino acids and proteins, from inorganic nitrogen compounds present in the environment. In nitrogen assimilation in plants, nitrate (NO₃⁻) and nitrite (NO₂⁻) are first reduced to ammonium (NH₄⁺) by nitrate reductase (NR) and nitrite reductase (NiR), respectively, and then ammonium (NH₄⁺) is incorporated into amino acid via the glutamine synthetase (GS)-glutamate synthase (GOGAT) pathway.

Therefore, increasing activities of enzymes involved in nitrogen assimilation, such as nitrate reductase (NR), glutamine synthetase (GS), and glutamate synthase (GOGAT), in plant cells indicate that the plant synthesizes more amino acids and proteins. As used herein, the term “US No. 1 grade of potatoes” refers to potatoes meeting the following requirements according to United States Standards for Grades of Potatoes issued by the United States Department of Agriculture (USDA): a. similar varietal characteristics, except when designated as a mixed or specialty pack; b. firm; c. fairly clean; d. fairly well shaped; e. free from: 1. freezing; 2. blackheart; 3. late blight, southern bacterial wilt and ring rot; and, 4. soft rot and wet breakdown; f free from damage by any other cause; g. not less than 1-⅞ inches in diameter, unless otherwise specified in connection with the grade.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated. The term “a,” “an,” or “the” disclosed in the present invention is intended to cover one or more numerical values in the specification and claims unless otherwise specified. For example, “an element” indicates one or more than one element.

It is to be understood that both the foregoing general description and the following detailed description are exemplary and explanatory only and are not restrictive of the invention.

### EXAMPLES

### Example 1 Biochemistry Analysis

### 1. Plant Growth and Treatment

Soybean seeds (Kaohsiung 10, Kaohsiung District Agricultural Research and Extension Station, Kaohsiung, Taiwan) were seeded in pots containing culture medium (peat soil: vermiculite=3:1). Soybean plants were applied with a reagent at the stage of V1 (one set of unfolded trifoliolate leaves). Electron transport rate (ETR), soluble sugar content, nitrate reductase (NR) activity, glutamine synthetase (GS) activity, glutamate synthase (GOGAT) activity, and soluble protein content were analyzed 3 days after the application. Total nitrogen content was analyzed 9 days after the application. Corn seeds (Zea mays ‘White Pearl’) were seeded in pots containing culture medium (peat soil: vermiculite =3:1). Corn plants were applied with a reagent at the stage of V1 (first leaf collar). Electron transport rate (ETR), soluble sugar content, nitrate reductase (NR) activity, glutamine synthetase (GS) activity, glutamate synthase (GOGAT) activity, and soluble protein content were analyzed 4 days after the application. Total nitrogen content was analyzed 7 days after the application.

Canola seeds (InVigor 5440) were seeded in pots containing culture medium (peat soil: vermiculite=3:1). Canola plants were applied with a reagent after the first true leaf fully expanded. Electron transport rate (ETR), soluble sugar content, nitrate reductase (NR) activity, glutamine synthetase (GS) activity, glutamate synthase (GOGAT) activity, and soluble protein content were analyzed 3 days after the application. Total nitrogen content was analyzed 7 days after the application.

Wheat seeds (Taichung S. No. 2, Taichung District Agricultural Research and Extension Station, Taichung, Taiwan) were seeded in pots containing culture medium (peat soil: vermiculite=3:1). Wheat plants were applied with a reagent at stage 1 (one shoot with two leaves). Soluble sugar content, nitrate reductase (NR) activity, glutamine synthetase (GS) activity, glutamate synthase (GOGAT) activity, and soluble protein content were analyzed 4 days after the application. Total nitrogen content was analyzed 9 days after the application.

Tomato seeds (Farmers 301, Known-You Seed Co., Ltd, Kaohsiung, Taiwan) were seeded in pots containing culture medium (peat soil: vermiculite=3:2). Tomato plants were applied with a reagent after the first set of trifoliolate leaves fully expanded. Electron transport rate (ETR), soluble sugar content, nitrate reductase (NR) activity, glutamine synthetase (GS) activity, glutamate synthase (GOGAT) activity, and soluble protein content were analyzed 4 days after the application. Total nitrogen content was analyzed 10 days after the application.

### 2. Reagent and Application

Test group: The composition of the present invention (0.12 wt. % Kinetin, 1 wt. % GABA, and 2 wt. % choline chloride) was diluted 100-fold with water and then mixed with 0.1% (v/v) Tween 80. The mixture was then applied to plant foliage once.

Control group: 0.1% (v/v) Tween 80 solution was applied to plant foliage once.

### 3. Analyses

3.1 Electron Transport Rate (ETR): Leaves to be tested were wrapped by aluminum foil for 20 minutes and then tested with photosynthesis system (LI-6400XTQ, LI-COR Biosciences, Lincoln, Nebr., USA) under lights (1500 μmol photons m⁻² s⁻).
3.2 Content of Soluble Sugar: Sample leaves were immersed and ground in liquid nitrogen. One (1) ml of water and 0.1 gram of the leaf powder were mixed in a centrifuge tube and incubated at 80° C. for 2 mimutes. Solution of extraction is added on 30 mg activated charcoal, and incubated for 5 minutes. After centrifugation for 15 minutes, 20 μl supernatant of each sample is dried at 50° C. for 40 minutes to evaporate the ethanol, and 20 μl of distilled water is added to bring each sample to its original volume. 20 μl sample is added with glucose assay reagent, phosphoglucose isomerase, and phosphoglucose isomerase to determine the concentrations of glucose, fructose, and sucrose respectively. The content of soluble sugar was measured at 340 nm on a spectrophotometer (NANODROP2000C, Thermo Fisher Scientific, Waltham, Mass., USA). D-glucose (Sigma Aldrich, St. Louis, Mo., USA) was used to establish the standard curve. The total content of soluble sugar was obtained from the sum of glucose, fructose, and sucrose.
3.3 Key Enzymes in Nitrogen Assimilation
3.3.1 Activity of Nitrate Reductase (NR): Zero-point five (0.5) gram of fresh sample leaf and 1 ml of potassium phosphate buffer (100 mM, pH7.4) containing 7.5 mM cysteine, 1 mM EDTA, and 1.5% casein were ground in liquid nitrogen and then centrifuged at 4° C., 13,000 relative centrifugal field (rcf) for 30 minutes. Zero-point one (0.1) ml of the supernatant and 0.9 ml of reaction solution were incubated at 30° C. in a water bath for 30 minutes, and the reaction was stopped by adding 0.05 mL zinc acetate (1 M). The sample was centrifuged at room temperature, 3,000 rcf. The supernatant was transferred to a new tube and mixed with 0.5 mL sulphanilamide (5.8 mM) and 0.5 mL N-(1-naphthyl)ethylenediamine (0.8 mM). The mixture was incubated for 30 minutes. Absorbance at an optical density (O.D.) of 540 nm (A₅₄₀) was measured. One (1) unit (nmol NO₂⁻·g⁻¹FW) of nitrate reductase is defined as the amount of the enzyme required to produce 1 nmole NO₂⁻ in 1 minute.
3.3.2 Activity of Glutamine Synthetase (GS): Zero-point five (0.5) gram of fresh sample leaf was ground in liquid nitrogen. The leaf powder and 1 ml of extraction solution, containing 10 mM Tris-HCl (pH7.6), 1 mM MgCl₂, 1 mM EDTA, and 10 mM 2-Mercaptoethanol, were centrifuged at 4° C., 13,000 rcf for 30 minutes. Zero-point one (0.1) ml of the supernatant and 0.4 ml of reaction solution were incubated at 30° C. in a water bath for 30 minutes, and the reaction was stop by adding 1 mL of stop solution, containing 2.5 g FeCl₃, 5.0 g TCA in 100 mL HCl (1.5 N). The sample was centrifuged at room temperature, 3,000 rcf. Absorbance at an O.D. of 540 nm (A₅₄₀) of the supernatant was measured. One (1) unit (μmol γ-GMH·g⁻¹FW) of glutamine synthetase is defined as the amount of the enzyme required to produce 1 μmol L-Glutamic acid γ-monohydroxamate at 30° C. in 1 minute.
3.3.3 Activity of Glutamate Synthase (GOGAT): Zero-point five (0.5) gram of fresh sample leaf was ground in liquid nitrogen. The leaf powder and 1 ml of extraction solution, containing 10 mM Tris-HCl (pH7.6), 1 mM MgCl₂, 1 mM EDTA, and 10 mM 2-Mercaptoethanol, were centrifuged at 4° C., 13,000 rcf for 30 minutes. Zero-point-one-five (0.15) ml of the supernatant was mixed with the reaction solution containing 0.2 mL of 20 mM L-glutamine, 0.25 mL of 2 mM 2-oxoglutarate, 0.05 mL of 10 mM KCl, 1 mL of 25 mM Tris-HCl (pH7.6), and 0.1 mL 3 mM NADH to initiate the reaction. Fluorescence intensity at excitation/emission wavelengths of 340/445 nm was measured. One (1) unit (μmole NADH oxidized·min⁻¹·g⁻¹FW) of glutamate synthase is defined as the amount of the enzyme required to reduce 1 μmol NADH in 1 gram of fresh sample in 1 minute.
3.4.1 Content of Soluble Protein: One hundred (100) mg of fresh sample leaf was ground with about 1 ml of extraction solution containing 50 mM phosphate buffered saline (PBS, pH6.8) and 1% (v/v) sodium dodecyl sulfate (SDS) to extract soluble protein. The extraction was then centrifuged at 4° C., 12,000×g for 15 minutes, and the supernatant was collected and stored at 4° C. One (1) μl of the supernatant was mixed with 49 μl of 50 mM PBS (pH6.8) and 200 μl of Bradford reagent, and absorbance at an O.D. of 595 nm (A₅₉₅) of the mixture was measured. Concentration of soluble protein in a sample was calculated with the following equation.

$$( mg \cdot {g}^{- 1} F W ) = \frac{X \times {V}_{T} \times N}{W \times {V}_{S} \times 1000}$$

Concentration of soluble protein t,24
X: Amount of soluble protein based on the absorbance of a sample (μg)
V_{T}: Total volume of extraction (ml)
W: Fresh weight of a sample (g)
V_{S}: Sample volume (ml)
N: dilution factor
3.4.2 Total Nitrogen Content: Plant samples were air-dried at 50° C. overnight and then ground into powder. Six (6) to 8 mg sample powder was analyzed with Thermo Scientific™ FLASH 2000 Elemental Analyzer (Thermo Fisher Scientific, Waltham, Mass., USA).

### 4. Results

4.1 The composition of the present invention improves the efficiency of plants in converting solar energy into chemical energy.

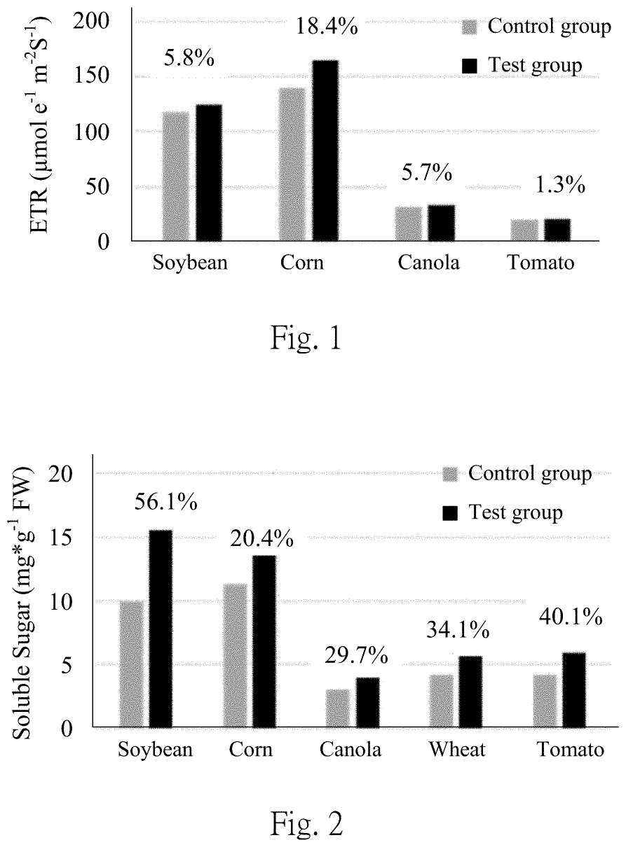

As shown in FIG. 1, the composition of the present invention increases electron transport rates (ETR) of plants for soybean, corn, canola, and tomato by 5.8%, 18.4%, 5.7%, and 1.3%, respectively, as compared with their corresponding control groups. The results indicate that the composition of the present invention promotes accumulation of energy in plants for absorbing CO₂ and synthesizing sugar.
4.2 The composition of the present invention improves the ability of plants to synthesize sugar by using CO₂.

As shown in FIG. 2, the composition of the present invention increases soluble sugar content of plants for soybean, corn, canola, wheat, and tomato by 56.1%, 20.4%, 29.7%, 34.1%, and 40.1%, respectively, as compared with their corresponding control groups. The results indicate that the composition of the present invention promotes carbon absorption and assimilation in plants.
4.3 The composition of the present invention improves activities of key enzymes in nitrogen assimilation in plants.

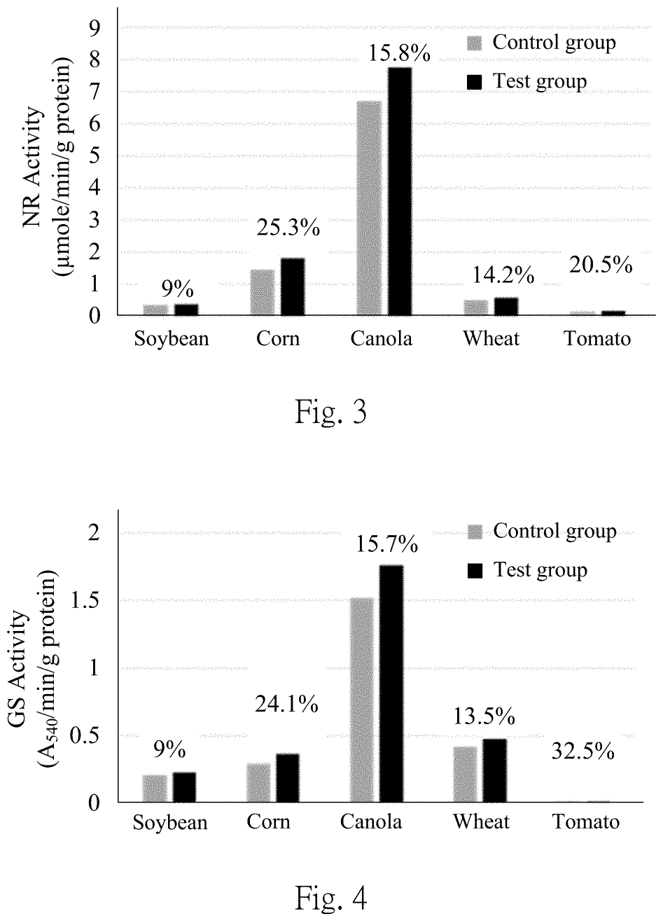

As shown in FIG. 3, the composition of the present invention increases activities of nitrate reductase (NR) of plants for soybean, corn, canola, wheat, and tomato by 9%, 25.3%, 15.8%, 14.2%, and 20.5%, respectively, as compared with their corresponding control groups. As shown in FIG. 4, the composition of the present invention increases activities of glutamine synthetase (GS) of plants for soybean, corn, canola, wheat, and tomato by 9%, 24.1%, 15.7%, 13.5%, and 32.5%, respectively, as compared with their corresponding control groups. As shown in FIG. 5, the composition of the present invention increases activities of glutamate synthase (GOGAT) of plants for soybean, corn, canola, wheat, and tomato by 15%, 16.7%, 9.1%, 8.4%, and 37.1%, respectively, as compared with their corresponding control groups. The results indicate that the composition of the present invention promotes nitrogen assimilation in plants, increases nitrogen utilization efficiency in plants, and therefore, reduces loss of nitrogen fertilizer.
4.4 The composition of the present invention increases content of protein and nitrogen compounds in plants.

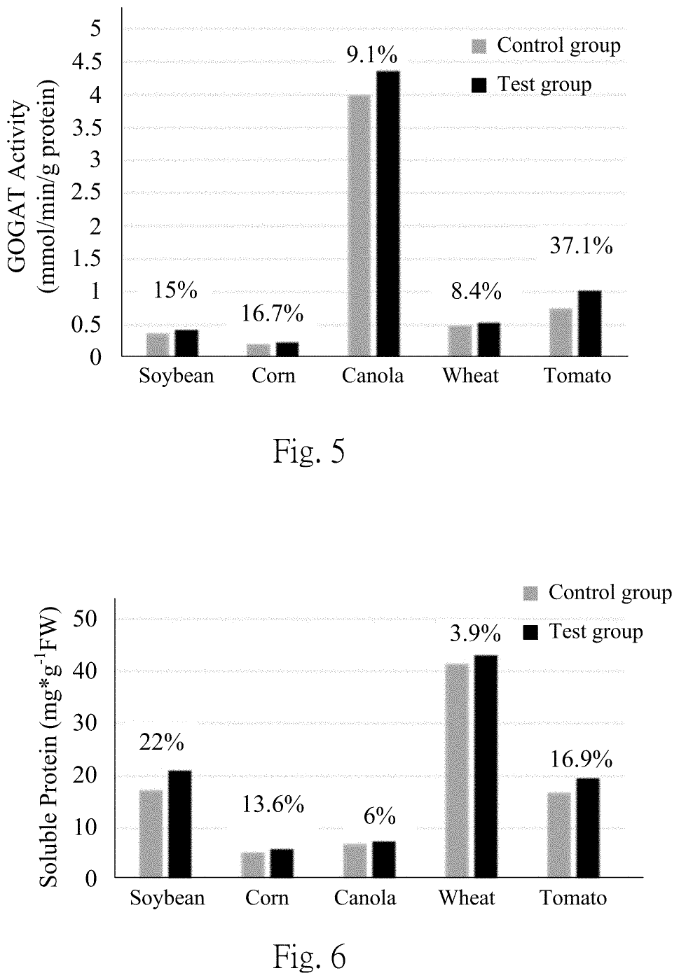

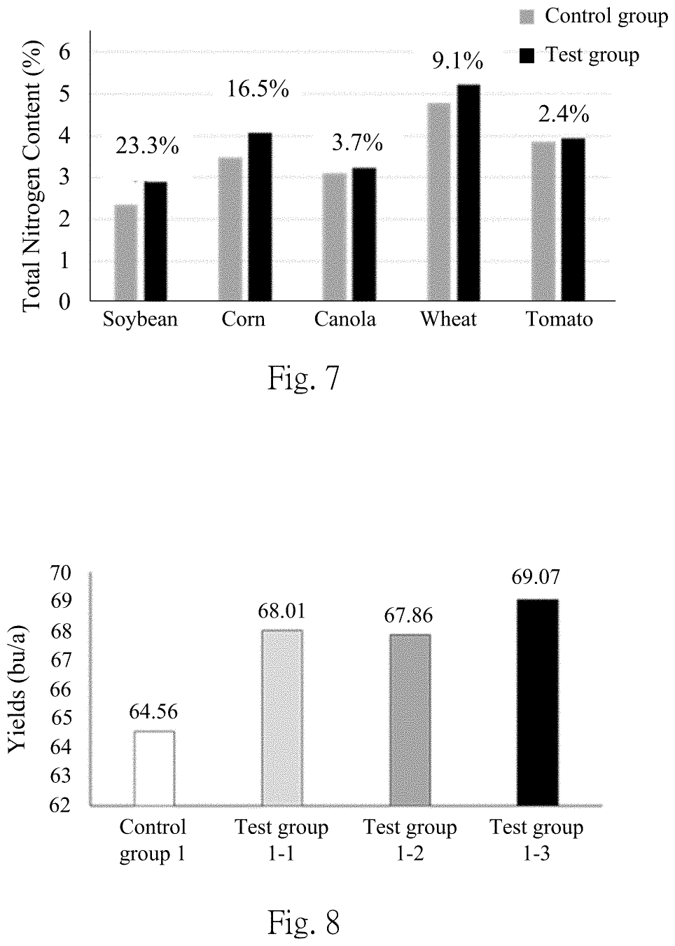

As shown in FIG. 6, the composition of the present invention increases content of soluble proteins of plants for soybean, corn, canola, wheat, and tomato by 22%, 13.6%, 6%, 3.9%, and 16.9%, respectively, as compared with their corresponding control groups. As shown in FIG. 7, the composition of the present invention increases total nitrogen content of plants for soybean, corn, canola, wheat, and tomato by 23.3%, 16.5%, 3.7%, 9.1%, and 2.4%, respectively, as compared with their corresponding control groups. The results also indicate that the composition of the present invention promotes nitrogen assimilation in plants, increases nitrogen utilization efficiency in plants, and therefore, reduces loss of nitrogen fertilizer.

### Example 2 Soybean Field Trials

### A. Field Trial 1

The soybean (variety: P32T25R2) field trial was carried out at Erie, Ill., USA. Harvested plot size was 10×36.5 feet, and replications per treatment was 4.

Test reagent: The composition of the present invention (0.12 wt. % Kinetin, 1 wt. % GABA, and 2 wt. % choline chloride) was diluted 100-fold with water and then mixed with 0.125% (v/v) LI 700® (Loveland Products, Loveland, Colo., USA). LI 700® is a drift control agent containing 80 wt % phosphatidylcholine, methylacetic acid, and alkyl polyoxyethylene ether and 20 wt % constituents ineffective as spray adjuvant.

Test group 1-1: Soybean plants were applied with the test reagent once at the stage of R1 (beginning flowering) at a rate of 15 gallon/acre using a foliar spray treatment.

Test group 1-2: Soybean plants were applied with the test reagent once at the stage of R2 (full flowering) at a rate of 15 gallon/acre using a foliar spray treatment.

Test group 1-3: Soybean plants were applied with the test reagent three times, at the stage of R1 (beginning flowering), R2 (full flowering), and 14 days after R2, respectively, at a rate of 15 gallon/acre using a foliar spray treatment.

Control group 1: Standard maintenance (i.e., standard fertilizer treatments) was applied to soybean plants of the control group.

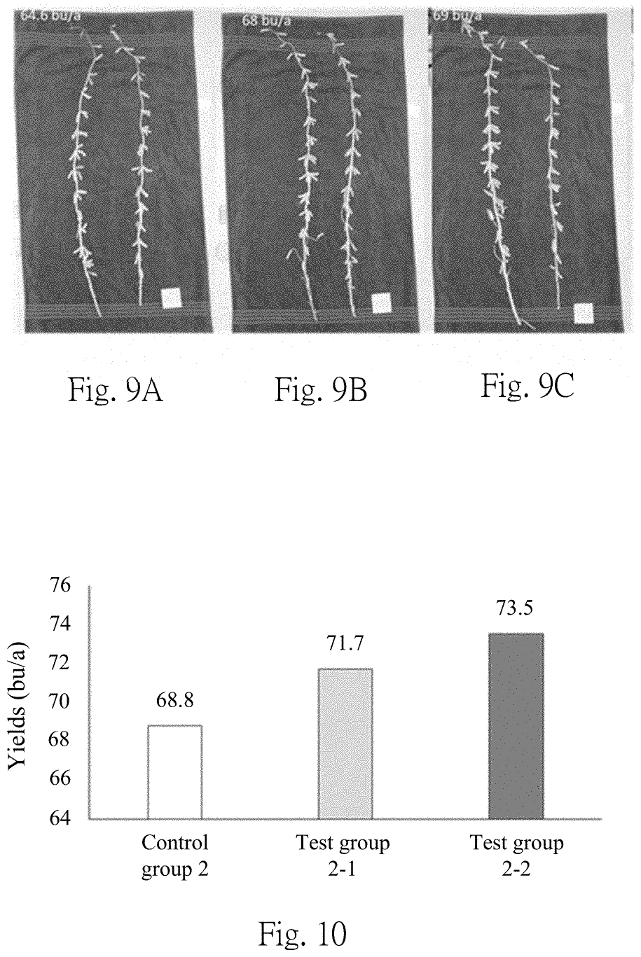

Soybean yield was estimated after harvest. The results are shown in FIG. 8. Soybean yield of control group 1 was 64.56 bushel/acre (bu/a), whereas soybean yields of test groups 1-1, 1-2, and 1-3 were 68.01 bu/a, 67.86 bu/a, and 69.07 bu/a, respectively. The results indicate that the composition of the present invention increases soybean yields. In addition, soybean plants that were applied with the composition of the present invention once at the stage of R1 (test group 1-1, FIG. 9B) and that were applied with the composition of the present invention three times (test group 1-3, FIG. 9C) both have more seed pods on main stems than soybean plants of control group 1 (FIG. 9A).

### B. Field Trial 2

The soybean (variety: Beck's 298LL) field trial was carried out at Erie, Ill., USA.

Harvested plot size was 10×36.5 feet, and replications per treatment was 4.

Test reagent: Same as Field Trial 1.

Test group 2-1: Soybean plants were applied with the test reagent once at the stage of R1 (beginning flowering) at a rate of 15 gallon/acre using a foliar spray treatment.

Test group 2-2: Soybean plants were applied with the test reagent twice, at the stage of R1 (beginning flowering) and 14 days after R1, respectively, at a rate of 15 gallon/acre using a foliar spray treatment.

Control group 2: Standard maintenance (i.e., standard fertilizer treatments) was applied to soybean plants of the control group.

Soybean yield was estimated after harvest. The results are shown in FIG. 10. Soybean yield of control group 2 was 68.8 bu/a, whereas soybean yields of test groups 2-1 and 2-2 were 71.7 bu/a and 73.5 bu/a, respectively. The results indicate that the composition of the present invention increases yields of soybean varieties.

### Example 3 Corn Field Trial

The corn (variety: Beck's 6418A3) field trial was carried out at Bagley, Iowa, USA. Harvested plot size was 5×47 feet, and replications per treatment was 4.

Test reagent: The composition of the present invention (0.12 wt. % Kinetin, 1 wt. % GABA, and 2 wt. % choline chloride) was diluted 100-fold with water and then mixed with 0.125% (v/v) LI 700® as spray adjuvant.

Test group: Corn plants were applied with the test reagent once at the stage of VT (tasseling) at a rate of 15 gallon/acre using a foliar spray treatment.

Control group: Standard maintenance (i.e., standard fertilizer treatments) was applied to corn plants of the control group.

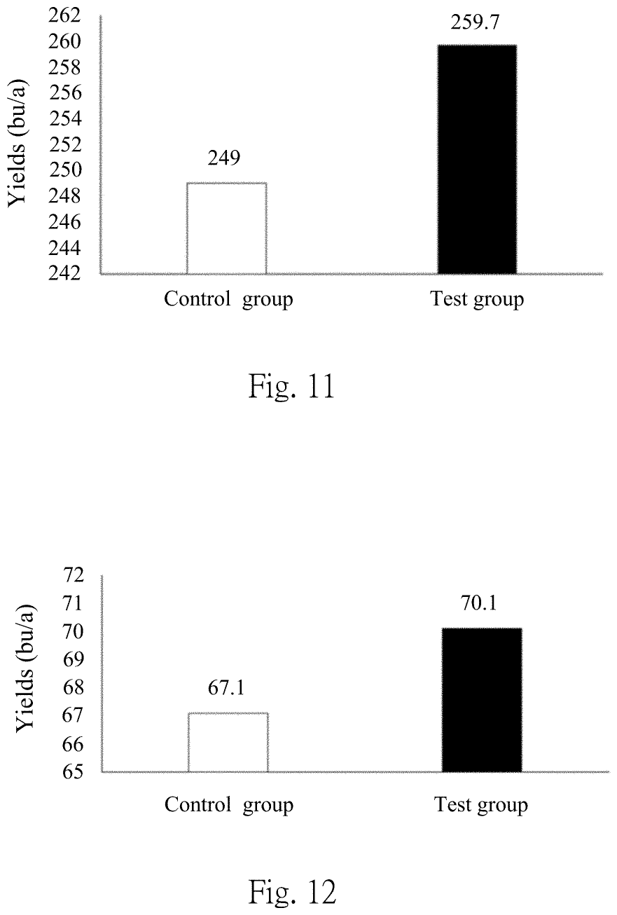

Corn yield was estimated after harvest. The results are shown in FIG. 11. Corn yield of the control group was 249 bu/a, whereas corn yields of the test group was 259.7 bu/a. The results indicate that the composition of the present invention increases corn yields.

### Example 4 Canola Field Trial

The canola (variety: PV580) field trial was carried out at Codette, Saskatchewan, Canada.

Individual plot size was 5×15 feet, and replications per treatment was 6.

Test reagent: The composition of the present invention (0.12 wt. % Kinetin, 1 wt. % GABA, and 2 wt. % choline chloride) was diluted 100-fold with water and then mixed with 0.25% (v/v) LI 700® as spray adjuvant.

Test group: Canola plants were applied with the test reagent twice, at growth stage 53 (GS53, flower buds raised above the youngest leaves) and growth stage 63 (GS63, 30% of flowers open on the main raceme), respectively, at a rate of 20 gallon/acre using a foliar spray treatment.

Control group: Standard maintenance (i.e., standard fertilizer treatments) was applied to canola plants of the control group.

Canola yield was estimated after harvest. The results are shown in FIG. 12. Canola yield of the control group was 67.1 bu/a, whereas canola yield of the test group was 70.1 bu/a. The results indicate that the composition of the present invention increases canola yields.

### Example 5 Cotton Field Trial

The cotton (variety: HBK LL 4953) field trial was carried out at Winchester, Ark., USA. Harvested plot size was 4×6 meters, and replications per treatment was 4.

Test reagent: The composition of the present invention (0.12 wt. % Kinetin, 1 wt. % GABA, and 2 wt. % choline chloride) was diluted 100-fold with water and then mixed with 0.25% (v/v) LI 700® as spray adjuvant.

Radiate® reagent: Radiate® (EPA Reg. No. 34704-909; active ingredients: 0.85 wt % 3-indolebutryic acid (IBA) and 0.15 wt % cytokinin, as kinetin) (Loveland Products, Loveland, Colo., USA) was diluted 640-fold with water and then mixed with 0.25% (v/v) LI 700® as spray adjuvant.

Test group 1: Cotton plants were applied with the test reagent once after the first flower emergence at a rate of 10 gallon/acre using a foliar spray treatment.

Test group 2: Cotton plants were applied with Radiate® reagent once after the fourth leaf fully expanded at a rate of 2 fluid ounces/acre using a foliar spray treatment, and then were applied with the test reagent once after the first flower emergence at a rate of 10 gallon/acre using a foliar spray treatment.

Control group: Standard maintenance (i.e., standard fertilizer treatments) was applied to cotton plants of the control group.

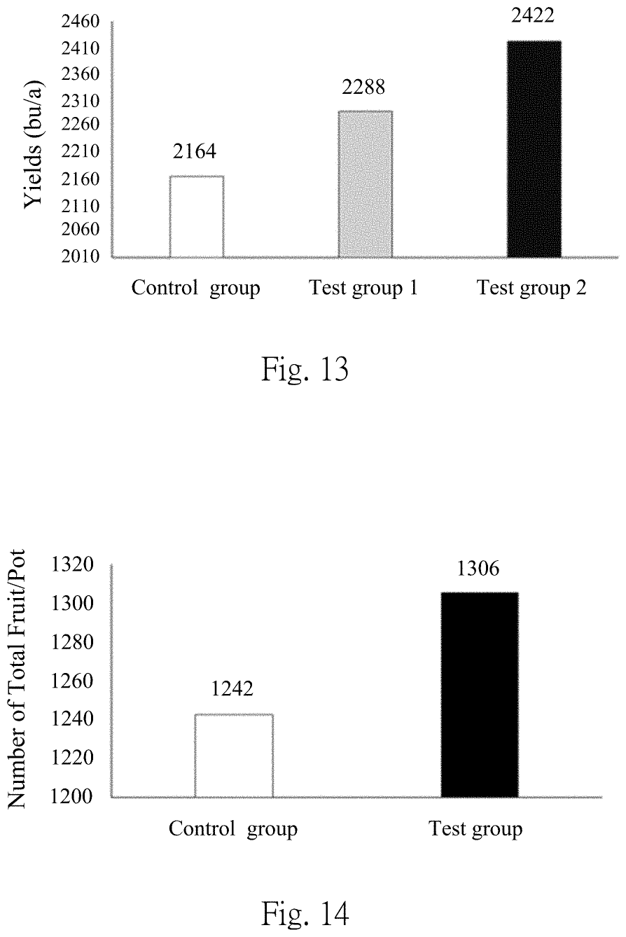

Cotton yield was estimated after harvest. The results are shown in FIG. 13. Cotton yield of the control group was 2,164 pounds/acre (Ib/a), whereas cotton yield of test group 1 was 2,288 lb/a. The results indicate that the composition of the present invention increases cotton yields.

In addition, the yield of cotton plants that were applied with Radiate® reagent once during vegetative growth and applied with the composition of the present invention once during reproductive growth (test group 2, 2422 lb/a) was higher than the yield of cotton plants that were applied only with the composition of the present invention once (test group 1, 2288 lb/a).

### Example 6 Tomato Field Trial

The tomato (variety: Charger) field trial was carried out at Thonotosassa, Fl., USA. Individual plot size was 10×50 feet, and replications per treatment was 6.

Test reagent: The composition of the present invention (0.12 wt. % Kinetin, 1 wt. % GABA, and 2 wt. % choline chloride) was diluted 100-fold with water and then mixed with 0.25% (v/v) LI 700® as spray adjuvant.

Test group: Tomato plants were applied with the test reagent three times, at the stage of 10% bloom (at a rate of 50 gallon/acre), full bloom (at a rate of 100 gallon/acre), and 14 days after full bloom (at a rate of 100 gallon/acre), respectively, using a foliar spray treatment.

Control group: Standard maintenance (i.e., standard fertilizer treatments) was applied to tomato plants of the control group.

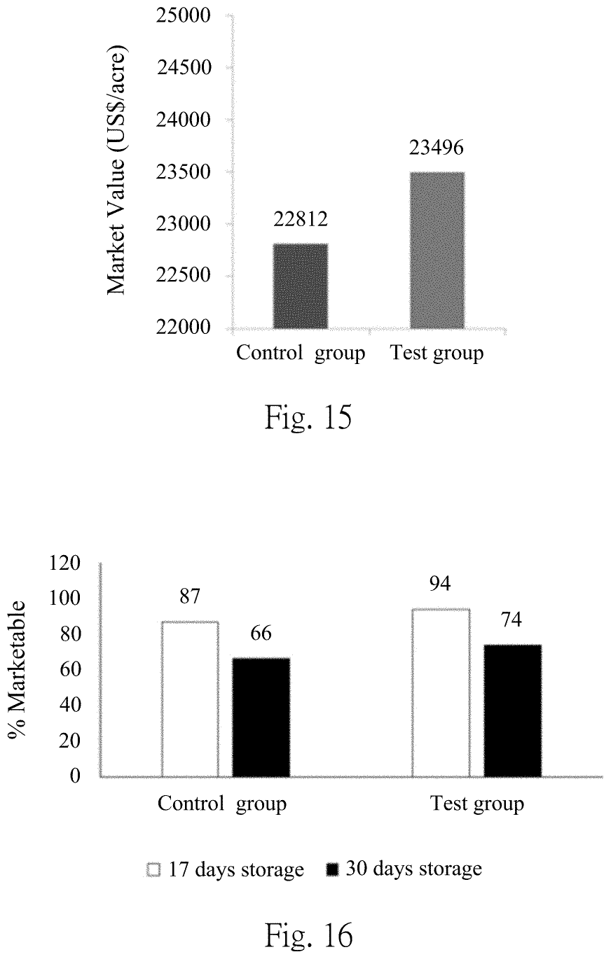

Yields and market value of marketable tomato were estimated after harvest. As shown in FIG. 14, yields of marketable tomato of the control group was 1,242 fruits/plot, whereas yields of marketable tomato of the test group was 1,306 fruits/plot. Also, as shown in FIG. 15, market value of the tomato of the control group was USD $22,812/acre, whereas market value of the tomato of the test group was USD $23,496/acre. The results indicate that the composition of the present invention increases tomato yields and market value. In addition, as shown in FIG. 16, after 17 days storage, marketable tomato of the control group reduced to 87% of the fresh marketable tomato, whereas marketable tomato of the test group remained 94% of the fresh marketable tomato. Similarly, after 30 days storage, marketable tomato of the control group reduced to 66% of the fresh marketable tomato, whereas marketable tomato of the test group reduced to 74% of the fresh marketable tomato. The results indicate that the composition of the present invention extends shelf life of tomato.

### Example 7 Potato Field Trial

The potato (variety: Russet Norkotah) field trial was carried out at Sturgis, Mich., USA. Harvested plot size was 2×6 meters, and replications per treatment was 4.

Test reagent: The composition of the present invention (0.12 wt. % Kinetin, 1 wt. % GABA, and 2 wt. % choline chloride) was diluted 100-fold with water and then mixed with 0.25% (v/v) LI 700® as spray adjuvant.

Test group: Potato plants were applied with the test reagent three times at the stage of early bloom, 14 days after early bloom, and 28 days after early bloom, respectively, at a rate of 20 gallon/acre using a foliar spray treatment.

Control group: Standard maintenance (i.e., standard fertilizer treatments) was applied to potato plants of the control group.

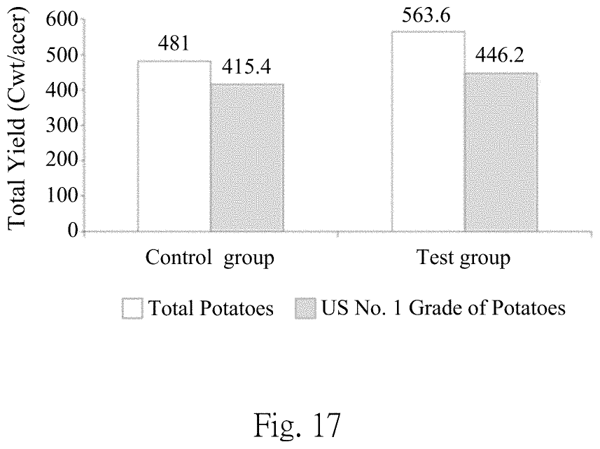

Potato yield was estimated after harvest. The results are shown in FIG. 17. Total potato yield of the control group was 481.0 hundredweight per acre (Cwt/a), whereas total potato yield of the test group was 563.6 Cwt/a. In addition, yield of US No. 1 grade of potatoes of the control group was 415.4 Cwt/a, whereas yield of US No. 1 grade of potatoes of the test group was 446.2 Cwt/a. The results indicate that the composition of the present invention increases yields of total potato and US No. 1 grade of potatoes. Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A composition for increasing productivity in plants, comprising
between about 0.005% to about 0.96 wt % cytokinin;
between about 0.04 wt % to about 8 wt % γ-Aminobutyric acid (GABA);
between about 0.08 wt % to about 16 wt % choline chloride; and
water.

2. The composition of claim 1, wherein the cytokinin is selected from N6-furfuryladenine (kinetin), 6- Benzylaminopurine (BA), zeatin (ZT), N6-(2-isopentenyl) adenine (2ip), diphenylurea (DPU), and thidiazuron (TDZ).

3. The composition of claim 1, wherein the composition consists essentially of:
between about 0.005% to about 0.96 wt % cytokinin;
between about 0.04 wt % to about 8 wt % γ-Aminobutyric acid (GABA);
between about 0.08 wt % to about 16 wt % choline chloride; and
water.

4. The composition of claim 1, wherein the composition increases productivity in plants by at least one of the methods selected from the group consisting of increasing electron transport rate in the plants, increasing sugar content in leaves of the plants, increasing activity of nitrate reductase (NR) in the plants, increasing activity of glutamine synthetase (GS) in the plants, increasing activity of glutamate synthase (GOGAT) in the plants, increasing content of soluble proteins in the plants, and increasing total nitrogen content in the plants.

5. A ready to use composition for increasing productivity in plants, comprising between about 0.000012 wt % to about 0.0384 wt % cytokinin;
between about 0.0001 wt % to about 0.32 wt % γ-Aminobutyric acid (GABA);
between about 0.0002 wt % to about 0.64 wt % choline chloride; and
water.

6. The ready to use composition of claim 5, wherein the cytokinin is selected from N6-furfuryladenine (kinetin), 6-Benzylaminopurine (BA), zeatin (ZT), N6-(2-isopentenyl) adenine (2ip), diphenylurea (DPU), and thidiazuron (TDZ).

7. The ready to use composition of claim 5, wherein the ready to use composition consists essentially of:
between about 0.000012 wt % to about 0.0384 wt % cytokinin;
between about 0.0001 wt % to about 0.32 wt % γ-Aminobutyric acid (GABA);
between about 0.0002 wt % to about 0.64 wt % choline chloride; and
water.

8. The ready to use composition of claim 5, wherein the ready to use composition increases productivity in plants by at least one of the methods selected from the group consisting of increasing electron transport rate in the plants, increasing sugar content in leaves of the plants, increasing activity of nitrate reductase (NR) in the plants, increasing activity of glutamine synthetase (GS) in the plants, increasing activity of glutamate synthase (GOGAT) in the plants, increasing content of soluble proteins in the plants, and increasing total nitrogen content in the plants.

9. A method for increasing productivity in plants, comprising a step of applying a ready to use composition to the plants, and the ready to use composition comprising
between about 0.000012 wt % to about 0.0384 wt % cytokinin;
between about 0.0001 wt % to about 0.32 wt % γ-Aminobutyric acid (GABA);
between about 0.0002 wt % to about 0.64 wt % choline chloride; and
water.

10. The method of claim 9, wherein the cytokinin is selected from N6-furfuryladenine (kinetin), 6- Benzylaminopurine (BA), zeatin (ZT), N6-(2-isopentenyl) adenine (2ip), diphenylurea (DPU), and thidiazuron (TDZ).

11. The method of claim 9, further comprising a step of mixing the ready to use composition with a drift control agent before the step of applying the ready to use composition to the plants.

12. The method of claim 9, wherein the ready to use composition increases productivity in plants by at least one of the methods selected from the group consisting of increasing electron transport rate in the plants, increasing sugar content in leaves of the plants, increasing activity of nitrate reductase (NR) in the plants, increasing activity of glutamine synthetase (GS) in the plants, increasing activity of glutamate synthase (GOGAT) in the plants, increasing content of soluble proteins in the plants, and increasing total nitrogen content in the plants.

13. The method of claim 9, further comprising a step of applying a second composition before the step of applying the ready to use composition to the plants, wherein the second composition consists essentially of between about 0.00027% wt % to about 0.00133 wt % 3-indolebutryic acid (IBA) and between about 0.00005 wt % to about 0.00023 wt % cytokinin.

14. The method of claim 13, wherein the cytokinin of the second composition is kinetin.
